(19) United States
(12) Patent Application Publication
(10) Pub. No.: US 2025/0261272 A1
(43) Pub. Date: Aug. 14, 2025

(54) METHODS AND APPARATUS FOR TRANSITIONING BETWEEN CONNECTIVITY STATES IN A WIRELESS COMMUNICATION NETWORK

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US)

(21) Appl. No.: 19/116,030

(22) PCT Filed: Sep. 27, 2023
(86) PCT No.: PCT/US2023/033866

§ 371 Date: Mar. 27, 2025

Related U.S. Application Data
(60) Provisional application No. 63/410,519, filed on Sep. 27, 2022.

(51) Int. Cl. H04W 76/27; H04W 16/22

(52) U.S. Cl. CPC H04W 76/27; H04W 16/22

(57) ABSTRACT

In an embodiment, a method implemented in a wireless transmit receive unit, WTRU, comprises: receiving in one or more first messages from a network, information on predictive data configuration indicating one or more triggering conditions for performing connection to the network and indicating one or more data traffic prediction parameters; determining a data traffic prediction level while in idle/inactive state based on the one or more data traffic prediction parameters: in response to the determination of the data traffic prediction level fulfilling at least one of the one or more triggering conditions, transmitting, to the network, a second message comprising a request for connection and at least one cause value for the connection: receiving, from the network, a third message comprising a response to the request for connection; and initiating a transition to connected state.

### CROSS-REFERENCE TO RELATED APPLICATIONS

The present application claims the benefit of U.S. Provisional Patent Application No. 63/410,519 filed Sep. 27, 2022, which is incorporated herein by reference in its entirety.

### TECHNICAL FIELD

This disclosure pertains to methods and apparatus for a wireless transmit/receive unit to transition between connectivity states in a network based on prediction of the future arrival of uplink or downlink data for transmission/reception by a wireless transmitter/receiver unit, WTRU.

### BACKGROUND

A transition of a wireless transmitter/receiver (WTRU) unit from a CONNECTED mode to INACTIVE/IDLE state is currently mainly based on a network monitoring the activity level of the WTRU and deciding to transition the WTRU to INACTIVE/IDLE state. A WTRU that has been sent to IDLE/INACTIVE state may end up transitioning back to CONNECTED state very soon afterwards, due to the arrival of UL or DL data. On the other hand, a WTRU may remain in the INACTIVE/IDLE state for a long time, which means, it could have been optimal for the network (and also for WTRU power saving) to transition the WTRU to INACTIVE/IDLE state even earlier. Current mechanisms for transitioning the WTRU from/to RRC_CONNECTED to/from RRC_INACTIVE/RRC_IDLE are based only on the current data activity of the WTRU, and could lead to sub-optimal resource utilization, unnecessary signaling and even sub-optimal WTRU power usage.

There is a need to improve current mechanisms for transitioning the WTRU from/to CONNECTED state to/from INACTIVE/IDLE state not only based on current data activity.

### SUMMARY

In an embodiment, a method implemented in a wireless transmit receive unit, WTRU, may comprise a step of receiving in one or more first messages from a network, information on predictive data configuration indicating one or more triggering conditions for performing connection to the network and indicating one or more data traffic prediction parameters. The method may further comprise a step of determining a data traffic prediction level while in idle/inactive state based on the one or more data traffic prediction parameters. In response to the determination of the data traffic prediction level fulfilling at least one of the one or more triggering conditions, the method may comprise a step of transmitting, to the network, a second message comprising a request for connection and at least one cause value for the connection. The method may further comprise a step of receiving, from the network, a third message comprising a response to the request for connection; and a step of initiating a transition to connected state.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram illustrating an radio resource control (RRC) connection/establishment procedure;

FIG. 3 is a signal flow diagram illustrating a connection resume procedure;

FIG. 4 is a transition diagram illustrating the different RRC states of a WTRU and the transitions between them;

FIG. 5 is a diagram illustrating a short buffer status report, BSR, MAC CE;

FIG. 6 is a diagram illustrating an Extended Short BSR;

FIG. 7 is a diagram illustrating a Long BSR MAC CE;

FIG. 8 is a signal flow diagram illustrating WTRU capability information transfer between a WTRTU and the network;

FIG. 9 is a signal flow diagram illustrating signal flow between a WTRU and the network in response to predicted UL data for the WTRU in accordance with an embodiment;

FIG. 10 is a signal flow diagram illustrating signal flow between a WTRU and the network in response to a prediction that there will be no UL data for the WTRU for a period in accordance with an embodiment; and

FIG. 11 is a flow chart illustrating an example of a method, implemented in a WTRU, for transitioning between connectivity states in a wireless communication network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

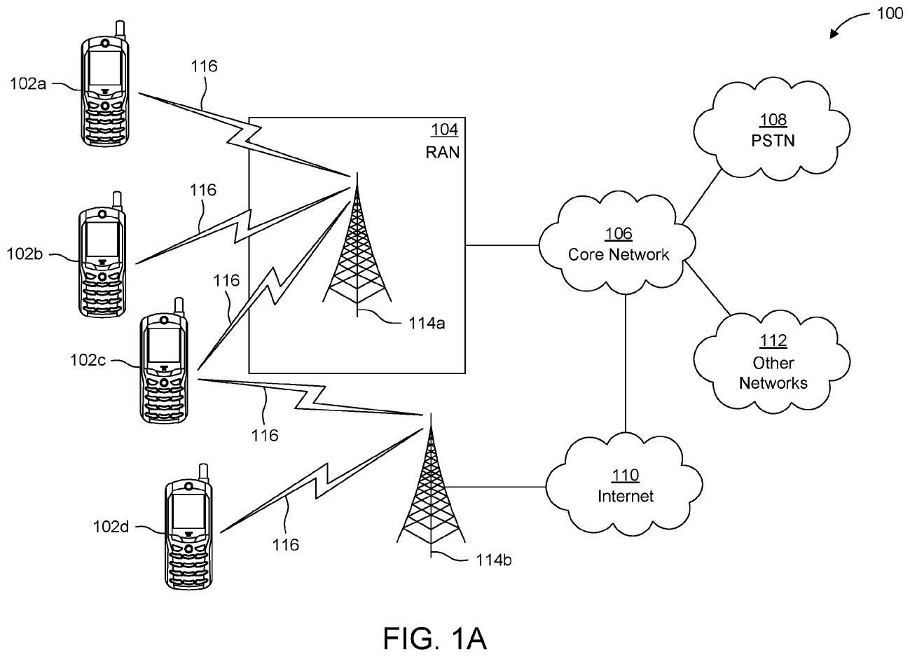

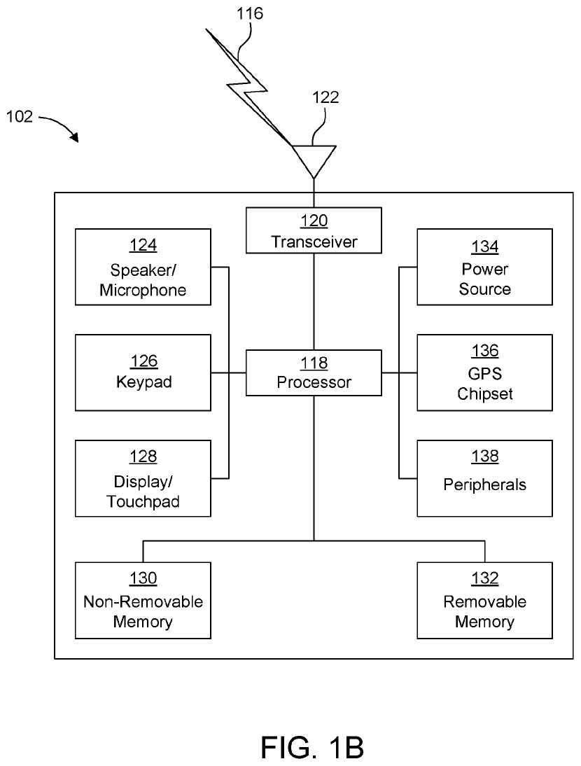

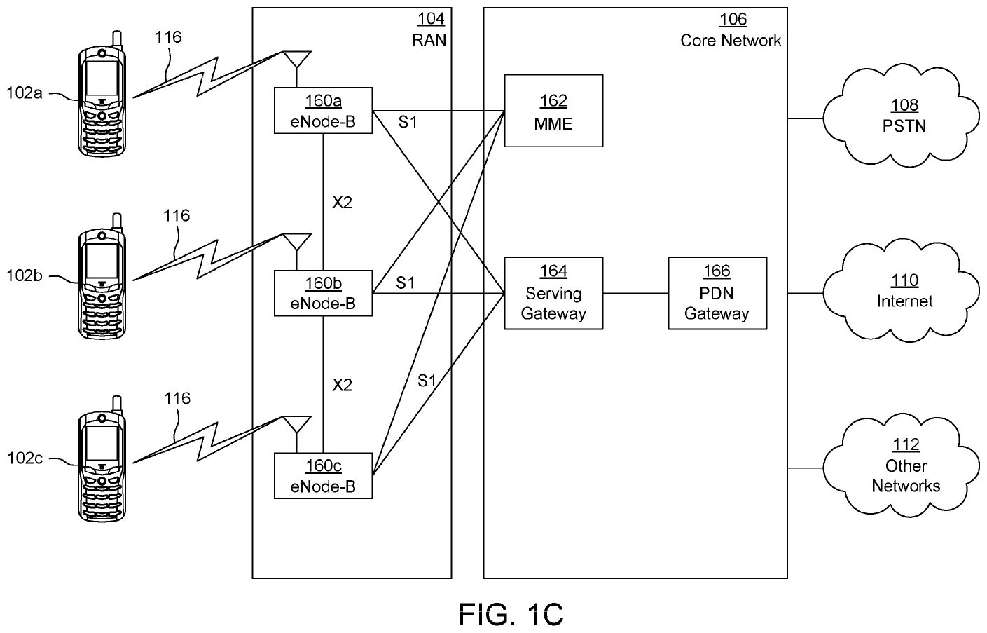

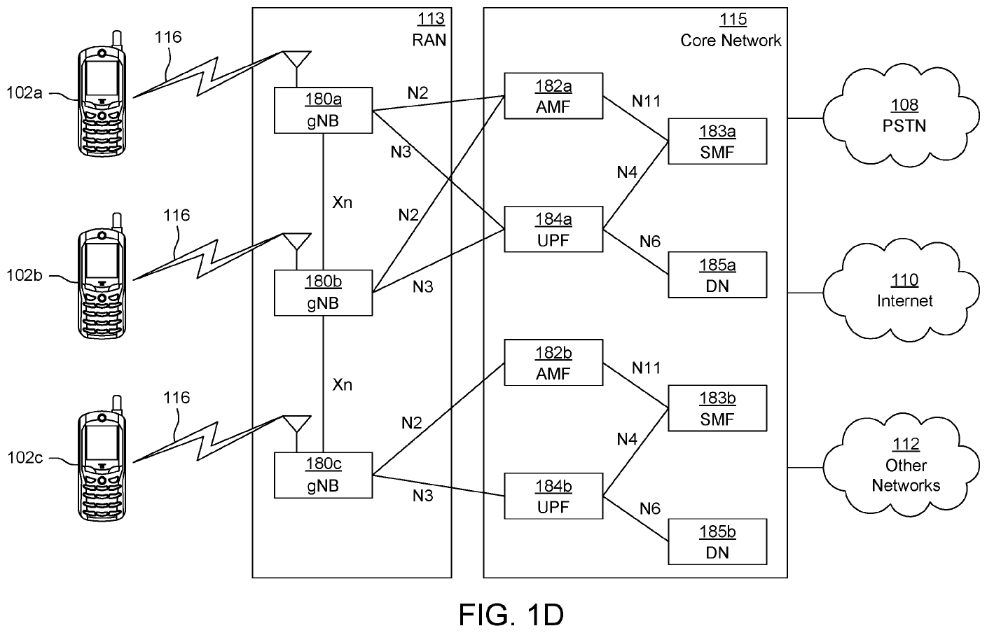

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In NR (New Radio), a WTRU may be in one of the following three radio resource control, RRC, states: RRC_CONNECTED (also referred to as “CONNECTED mode” in this document); RRC_INACTIVE (also referred to as “INACTIVE mode” in this document); RRC_IDLE (also referred to as “IDLE mode” in this document).

In RRC_CONNECTED, the WTRU may be actively connected to the network, with signaling and data radio bearers established (Signaling Radio Bearers (SRBs) and data radio bearers (DRBs)), and able to receive downlink (DL) data from the network in a unicast fashion and also send Uplink (UL) data to the network. The mobility of the WTRU from one cell/node to another is controlled by the network. The network may configure the WTRU to send measurement reports periodically or when certain conditions are fulfilled (e.g., a neighbor cell becomes better than a serving cell by more than a certain threshold) and, based on these reports, may send the WTRU a handover command to move the WTRU to another cell/node. The network may also configure a conditional handover (CHO) where, instead of sending a measurement report, the WTRU executes a preconfigured handover command when certain conditions are fulfilled. The network may also send the WTRU a Handover (HO) command without receiving any measurement report (e.g., based on implementation, such as determination of the current location).

Keeping the WTRU in connected state/mode may be power intensive for the WTRU (e.g., the WTRU needs to continuously monitor the PDCCH (Physical Downlink Control Channel) of the serving cell, e.g., for determining the arrival of DL data, for UL data scheduling, etc.). Furthermore, a certain cell/gNB may be able to accommodate a certain number of WTRUs in connected mode (e.g., due to resource limitations). As such, when there is no activity in the UL or DL for a WTRU for a certain duration (e.g., based on an inactivity timer kept at the network), the network may send the WTRU to the RRC_INACTIVE or RRC_IDLE state.

If the network expects the WTRU to become inactive for a long duration, it may send the WTRU to RRC_IDLE state. While in RRC_IDLE, the WTRU may camp at the best cell (the cell with the best signal level at the highest priority RAT and highest priority frequency within that RAT), that will facilitate the WTRU establishing the connection via that cell if a need arises for the WTRU to transition back to the connected state. More details of the cell re-selection procedure that ensures the WTRU is always camping at the best cell is given below. The WTRU may also monitor the downlink paging channel to monitor for DL data arrival. The WTRU may initiate the connection setup/establishment procedure if it detects a page from the network indicating arrival of DL data or if the WTRU needs to send UL data.

During connection setup or resume, the WTRU may first perform a random access (RA) procedure (also referred to as random access channel (RACH) procedure in this disclosure) before sending an RRCSetupRequest or RRCResumeRequest message. The RA procedure may serve two main purposes: UL synchronization between the WTRU and the network (e.g., gNB); and obtaining the resources that are to be used for sending the request message.

During the RA procedure, the WTRU may send a message on the RACH (referred to as msg1) that contains a Preamble and an RA-RNTI (Random Access-Radio Network Temporary Identifier) to the gNB. In the case of contention-based random access (CBRA), the preamble may be randomly selected out of a set of possible preamble values (i.e., there could be contention if another WTRU initiates a random access procedure using the same preamble value). In the case of contention free random access (CFRA), a specific preamble may be provided to the WTRU beforehand (e.g., when the WTRU was in connected state, during the transition to the IDLE/INACTIVE state, etc.). The RA-RNTI may be calculated based on the PRACH (physical RACH) occasion at which the random access message is to be sent to the network.

The gNB, upon receiving msg1, responds with msg2, which contains a random access response (RAR). In order for the WTRU to detect the RAR, the network may also send a DCI (Downlink Control Indicator) in the PDCCH that is scrambled with the RA-RNTI, which may be used by the WTRU to determine on which resources (e.g., time and frequency) that RAR (and other related info) is provided to the WTRU. The WTRU may try to detect this DCI within a period of time after sending the preamble (known as the RAR-window). If such DCI is not received, the WTRU may retransmit the preamble. If the DCI is received, the WTRU may detect the RAR at the indicated time and frequency resources in the PDSCH (Physical Downlink Shared Channel). In the RAR and associated information, the WTRU may be provided with the timing advance (TA) to apply for sending UL data, the TC-RNTI (temporary Cell RNTI), and the UL resources to send the setup/resume request message.

The WTRU may get the detailed information/configuration regarding the usage of the random access channel, such as RACH occasion, random access response window, etc., via dedicated configuration while in connected state, upon transitioning during an IDLE/INACTIVE state, or from a system information broadcast (SIB).

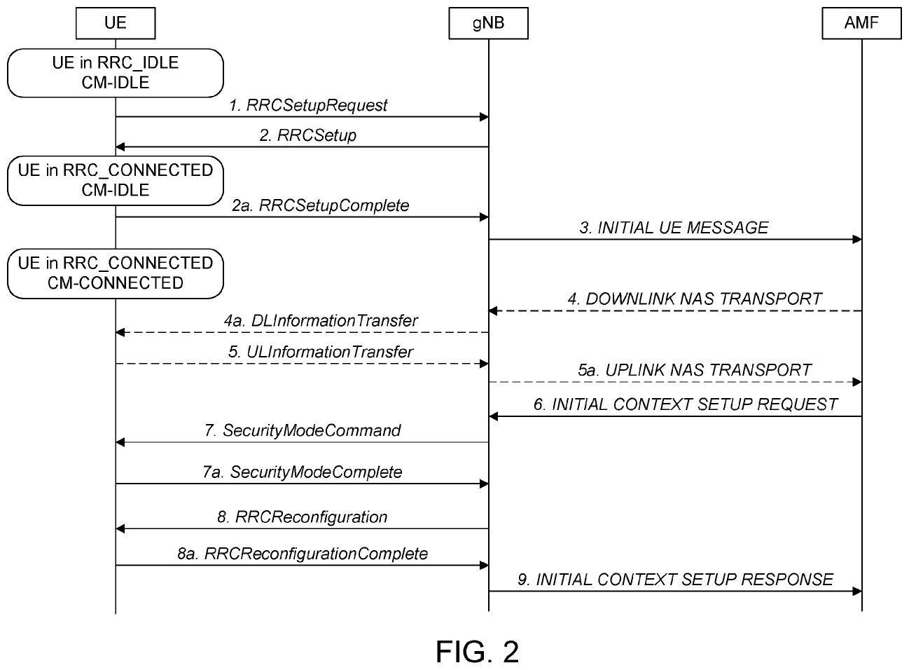

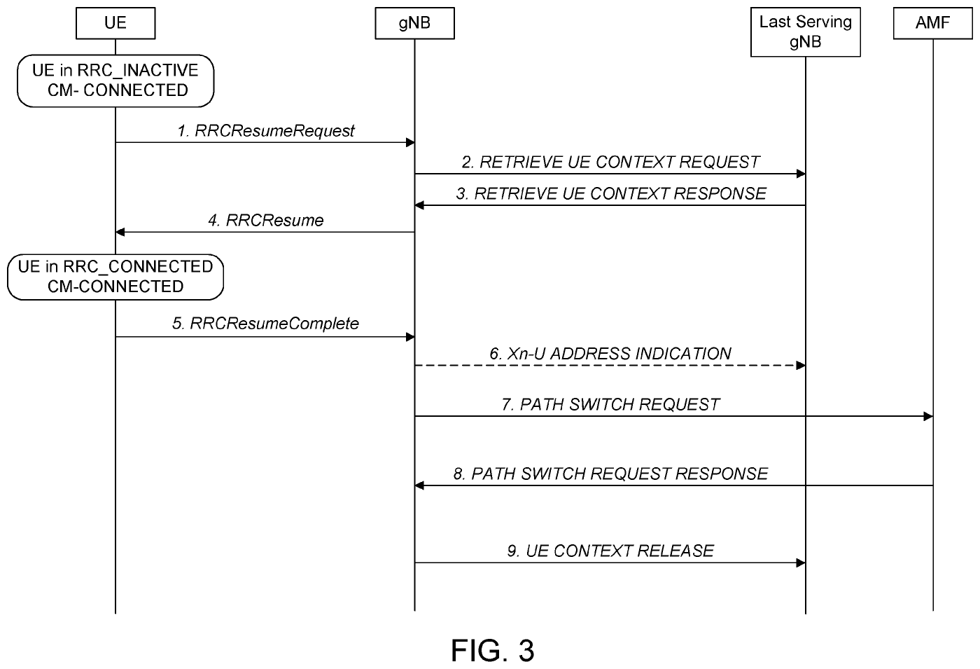

FIGS. 2 and 3 illustrate the RRC connection establishment/setup and connection resume procedures, respectively, as set forth in TS38.300 [4], sections 9.2.1.3 and 9.2.2.4.1, respectively.

The RA procedure is not shown in these FIGS., e.g., msg1 and msg 2. However, some of the follow up signaling, e.g., msg3, msg4, and msg5, are shown. For sake of clarity, note that: msg3 corresponds to a message sent after the RA response is received from the gNB (e.g., RRCResumeRequest or RRCSetupRequest); msg4 corresponds to refer to a response from the network to a msg3 sent from the UE (e.g., RRCResume or RRCSetup); and msg5 corresponds to the confirmation from the UE that the msg4 was executed properly (e.g., RRCResumeComplete or RRCSetupComplete). Also note that, if the WTRU resumes the connection in the same gNB, messages between the two gNBs and also between the gNBs and the Core Network (CN) CN may not be required, and, as such, the WTRU may be resumed without involving the CN).

As can be seen in FIG. 2, the RRC connection setup procedure may be a lengthy procedure that requires several round trip times to complete and involves the Core Network (CN). If the WTRU enters IDLE mode, the WTRU's RRC context may be released, and, as such, the WTRU may be not known to the cellular network at the RAN level. Thus, the RAN may obtain the WTRU context from the CN. Also, security may be re-established after that and the WTRU reconfigured with the DRBs and SRBs before UL/DL data transmission/reception may occur.

Such a lengthy setup procedure may not be compatible with low latency services and thus NR has introduced an intermediate state between the CONNECTED and IDLE state, known as the INACTIVE state. This state may have most of the power saving advantages of the IDLE state (e.g., the WTRU does not need to continuously monitor the PDCCH, which is one of the most power consuming procedures in the connected state), but at the same time, the RAN still keeps the WTRU's RRC/Security context. When there is a need to transition the WTRU to CONNECTED state/mode (e.g., due to the arrival of UL data or the reception of a page indicating the arrival of DL data), the connection may be resumed very quickly, without involving the CN, re-establishing the WTRU's security context, or reconfiguring the bearers.

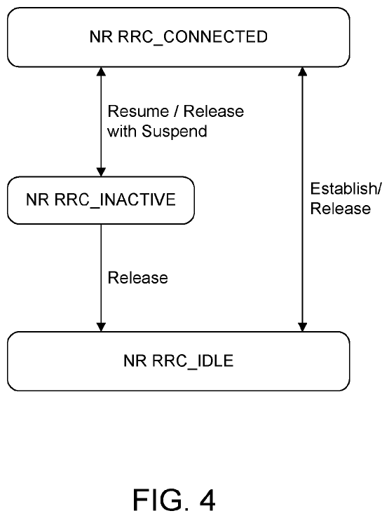

FIG. 4 summarizes the different RRC modes/states and the transitions between them.

When the WTRU performs the connection setup/establishment or resume procedure, it may include (in the RRCSetupRequest or RRCResumeRequest), the establishment or resume cause. Currently, the following causes may be defined as:

```
EstablishmentCause ::= ENUMERATED {
  emergency, highPriorityAccess, mt-Access, mo-Signalling,
    mo-Data, mo-VoiceCall, mo-VideoCall, mo-SMS,
    mps-PriorityAccess, mcs-PriorityAccess, spare6, spare5,
      spare4, spare3, spare2, spare1 }
ResumeCause ::= ENUMERATED { emergency, highPriorityAccess,
mt-Access, mo-Signalling,
  mo-Data, mo-VoiceCall, mo-VideoCall, mo-SMS, rna-Update,
    mps-PriorityAccess, mcs-PriorityAccess,
      spare1, spare2, spare3, spare4, spare5 }
```

For example, if the connection is being setup/resumed due to a voice call or video call originating from the WTRU, the WTRU may set the establishment/resume cause to mo-VoiceCall (mobile originated voice call) or mo-VideoCall (mobile originated video call). As another example, if the connection is being setup/resumed due to downlink paging indicating DL data, the WTRU will set the establishment/resume cause to one of mt-Access (mobile terminated access), highPriority Access, mps-Priority Access, or mcs-Priority Access (depending on the access category of the WTRU).

When the WTRU is sent to INACTIVE state, the network may include in the radio resource control release (RRCRelease) message a suspendConfig. The SuspendConfig contains information such as:
the resumeIdentity to be used by the WTRU (a short identity, shortI-RNTI, and a long identity, fullI-RNTI). The WTRU will determine which identity to use based on the system information broadcast in the target cell (e.g., if useFullResumeID is indicated in the SIB, use the long identity; otherwise, use the short identity).
The RAN paging area (e.g., list of cells): this is the RAN area where the WTRU can be paged at the RAN level. If the WTRU performs cell re-selection to a cell outside the RAN area, WTRU performs a RAN area update procedure.
nextHopChaining count: this is used for deriving the security context (e.g., encryption/integrity protection keys) upon resuming the connection.

The base station (gNB), specifically the MAC entity at the gNB, may be responsible for the scheduling of both uplink and downlink physical resources in NR.

In order to make efficient usage of the network's radio resources and also to do so in a manner that is fair to the different WTRUs that it is serving, the gNB may use information such as:
Buffer status related to the WTRU (e.g., pending data to be transmitted at the gNB in the DL for the WTRU, UL buffer status reported by the WTRU, etc.)
The QoS requirements of each WTRU and associated radio bearers
The radio conditions at the WTRU (e.g., identified through measurements made at the gNB and/or reported by the WTRU)
Power headroom at the WTRU, which is the difference between the WTRU's maximum transmit power and estimated power for UL transmission (e.g., as indicated by power headroom reports from the WTRU).

The gNB may use all the above information regarding the multitude of WTRUs that it is currently serving when it makes scheduling decision in both the UL and DL (i.e., which WTRU(s) get which UL/DL resources to transmit/receive). The gNB may do the scheduling in a dynamic fashion (e.g., the WTRUs being scheduled as well as which resources are assigned to these WTRUs are changing from one radio slot/frame to another) or in a persistent way (i.e., a certain set of radio resources allocated to a WTRU or group of WTRUs in the UL or DL for a given time). Persistent scheduling in the UL in NR is referred to as configured grants whereas in the DL it is called semi-persistent scheduling (SPS).

In the uplink, the gNB may dynamically allocate resources to WTRUs via the C-RNTI on PDCCH(s). A WTRU always monitors the PDCCH(s) to find possible grants for UL transmission. When CA (Carrier Aggregation) is configured, the same C-RNTI applies to all serving cells.

The gNB may cancel a PUSCH (Physical Uplink Shared Channel) transmission, or a repetition of a PUSCH transmission, or an SRS transmission of a WTRU for another WTRU with a latency-critical transmission. The gNB can configure WTRUs to monitor cancelled transmission indications using CI-RNTI on a PDCCH.

In addition, with configured grants, the gNB may allocate uplink resources for the initial HARQ transmissions and HARQ retransmissions to WTRUs. There are two types of configured uplink grants:
Type 1: RRC directly provides the configured uplink grant (including the periodicity).
Type 2: RRC defines the periodicity of the configured uplink grant while PDCCH addressed to CS-RNTI (Configured Scheduling-RNTI) can either signal and activate the configured uplink grant, or deactivate it, i.e., a PDCCH addressed to CS-RNTI indicates that the uplink grant can be implicitly reused according to the periodicity defined by RRC, until deactivated.

The WTRU may be configured with up to 12 active configured uplink grants for a given BWP (BandWidth Part) of a serving cell. When more than one is configured, the network decides which of these configured uplink grants are active at a time (including all of them). Each configured uplink grant can be of either Type 1 or Type 2. For Type 2, activation and deactivation of configured uplink grants are independent among the serving cells. When more than one Type 2 configured grant is configured, each configured grant may be activated separately using a DCI command, and deactivation of Type 2 configured grants may be done using a DCI command, which can either deactivate a single configured grant configuration or multiple configured grant configurations jointly.

For both dynamic grant and configured grant, for a transport block, two or more repetitions may be in one slot, or across slot boundaries in consecutive available slots with each repetition in one slot. For both dynamic grant and configured grant Type 2, the number of repetitions may also be dynamically indicated in L1 signaling. The dynamically indicated number of repetitions shall override the RRC configured number of repetitions, if both are present.

Uplink buffer status reports (BSRs) may be needed to provide support for QoS-aware packet scheduling. In NR, BSR is reported at a logical channel group (LCG) granularity. A WTRU may be configured with up to 32 logical channel IDs (LCID), and these can be grouped into as many as 8 LCGs. It should be noted that some special WTRUs may be configured with more than 32 LCIDs and more than 8 LCGs (e.g., the mobile termination (MT) of an integrated backhaul access (IAB) node may be configured with up to 65855 LCIDs and 256 LCGs).

A BSR may be sent in two formats: A short BSR format to report the data for only one LCG; and a long BSR format to report the data from several LCGs

BSRs may be transmitted using MAC Control Elements (MAC CEs). When a BSR is triggered (e.g., when new data arrives in the transmission buffers of the WTRU), if the WTRU does not have any available UL grants to send the BSR, a scheduling request (SR) may be transmitted by the WTRU to request the needed UL resources to transmit the BSR.

There are several variants of the short and long BSR (e.g., for the case of IAB MT), but for the sake of brevity, we include only a subset of them as shown below. The reader is referred to TS 38.321 for the details.

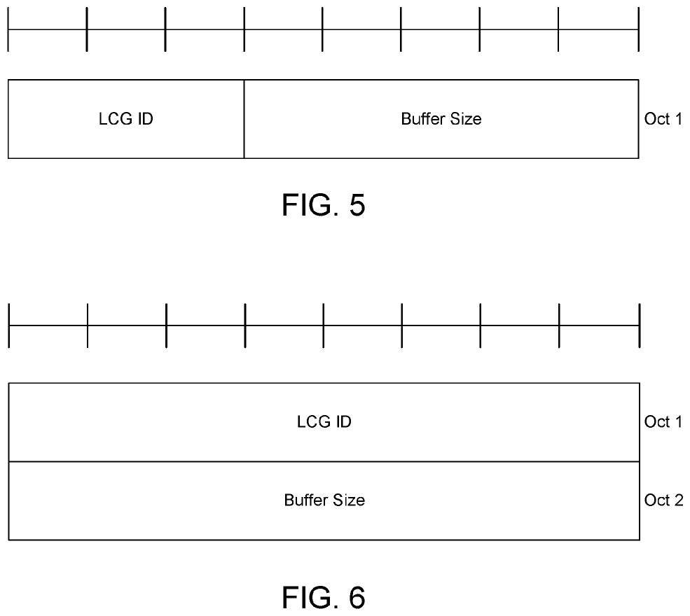

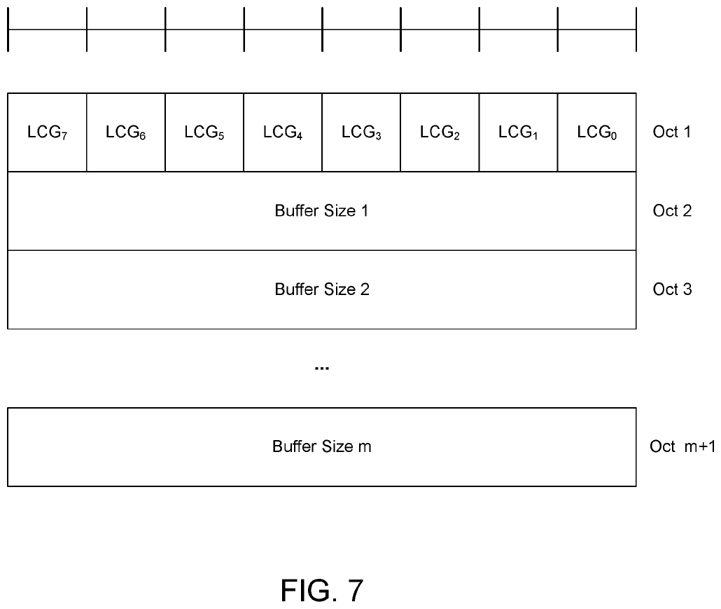

Some BSR formats are shown in FIGS. 5-7, namely, a short BSR MAC CE shown in FIG. 5, an Extended Short BSR shown in FIG. 6, and a Long BSR MAC CE shown in FIG. 7.

The buffer size included in the BSR reports may be coded according to the Table 1 and Table 2 below (e.g., the WTRU may include the index corresponding to the buffer size for the corresponding LCG).

TABLE 1
Buffer size levels (in bytes) for 5-bit Buffer Size field

| Index | BS value |
|---|---|
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

TABLE 2
Buffer size levels (in bytes) for 8-bit Buffer Size field

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

RRC may configure the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.

The MAC entity may determine the amount of UL data available for a logical channel according to the data volume calculation procedure performed at radio link control (RLC) and packet data convergence protocol (PDCP).

When performing the data volume calculation, RLC may include the RLC data PDUs that are pending transmission or retransmissions, RLC service data units (SDUs) (or segments of RLC SDUs) that have not been yet included in an RLC data PDU, and any pending RLC STATUS PDU (see TS 38.322 [1])

The data volume calculation at PDCP may consider the PDCP SDUs for which PDCP data PDUs have not been constructed, PDCP data PDUs that have not been transmitted to lower layers yet, any PDCP control PDUs, and any PDPC SDUs or PDUs that are to be retransmitted due to PDCP re-establishment or PDCP data recovery (see TS 38.323 [2]).

A WTRU may trigger a BSR if any of the following events occur:
UL data, for a logical channel which belongs to an LCG becomes available to the MAC entity; and either
   this UL data belongs to a logical channel with higher priority than the priority of any logical channel containing available UL data that belongs to any LCG; or
   none of the logical channels that belongs to an LCG contains any available UL data, in which case the BSR is referred to as ‘Regular BSR’;
UL resources are allocated and the number of padding bits is equal to or larger than the size of the Buffer Status Report MAC CE plus its subheader, in which case the BSR is referred to as ‘Padding BSR’;
retxBSR-Timer expires, and at least one of the logical channels that belongs to an LCG contains UL data, in which case the BSR is also referred to as ‘Regular BSR’;
periodicBSR-Timer expires, in which case the BSR is referred to as ‘Periodic BSR’.

When regular BSR triggering events occur for multiple logical channels simultaneously, each logical channel may trigger one separate Regular BSR.

A scheduling request (SR) may be used for requesting uplink shared channel (UL-SCH) resources for new transmission.

The MAC entity may be configured with zero, one, or more SR configurations. An SR configuration may comprise a set of PUCCH resources for SR across different BWPs and cells. At most, one PUCCH resource for SR is configured per BWP.

Each SR configuration may correspond to one or more logical channels. Each logical channel may be mapped to zero or one SR configuration, which is configured by RRC. The SR configuration of the logical channel that triggered a BSR may be considered as corresponding SR configuration for the triggered SR.

RRC may configure the following parameters for the scheduling request procedure: sr-ProhibitTimer (per SR configuration); sr-TransMax (per SR configuration).

The following WTRU variables may be used for the scheduling request procedure: SR_COUNTER (per SR configuration).

If an SR is triggered and there are no other SRs pending corresponding to the same SR configuration, the MAC entity may set the SR_COUNTER of the corresponding SR configuration to 0.

When an SR is triggered, it may be considered as pending until it is cancelled.

All pending SR(s) for BSR triggered according to the BSR procedure prior to the MAC PDU assembly may be cancelled and each respective sr-ProhibitTimer may be stopped when the MAC PDU is transmitted and this PDU may include a long or a short BSR MAC CE that contains buffer status up to (and including) the last event that triggered a BSR prior to the MAC PDU assembly. All pending SR(s) for BSR triggered according to the BSR procedure may be cancelled and each respective sr-ProhibitTimer may be stopped when the UL grant(s) can accommodate all pending data available for transmission.

Only PUCCH resources on a BWP that is active at the time of SR transmission occasion may be considered valid.

3GPP has started investigating the utilization of Artificial Intelligence/Machine Learning (AI/ML) mechanisms for optimized operation of the radio access network (RAN). For example, in the rel-17 study on enhancements for data collection for NR and EN-DC, several use cases have been identified [TS 37.817 [3]], such as: network energy saving, load balancing, and mobility optimization.

AI/ML models may be proposed to be used by the network and/or WTRU to predict different aspects such as WTRU trajectory, WTRU traffic, serving and neighbor cell signal levels, etc. And based on these predictions, the network may make more optimized and proactive decisions instead of the legacy way of operating in a reactive manner (e.g., handover when the signal level of a neighbor cell becomes better than the serving cell, traffic steering/load balancing once the serving cell becomes overloaded, etc.).

The predictions may be made by the network, the WTRU, or a collaboration between the two. For example, in the area related to traffic prediction, the WTRU may be provided with an AI/ML model (e.g., provided by the network, proprietary model by the WTRU vendor or operator, etc.), and once that model is well-trained (e.g., for a certain period of time until the WTRU has verified the predictions are with a certain level of acceptable accuracy or error margin), the WTRU may be configured to send predictive BSRs even before actual traffic has arrived at the WTRU buffers, giving the network a lead time, and enabling it to make more optimized decisions (e.g., giving more configured/dynamic grants, configuring additional carriers or/and dual connectivity, offloading the concerned WTRU or other WTRU to neighboring cells preemptively, etc.), to make sure resources will be available to that WTRU by the time that the predicted data is actually available and ready to be sent at the WTRU buffers.

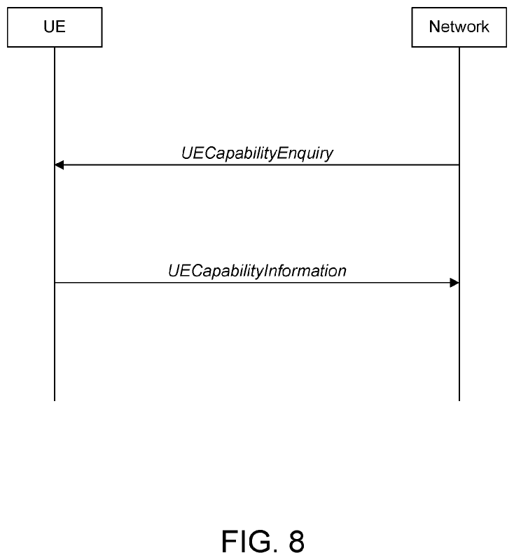

As shown in FIG. 8, in NR, the WTRU may compile and may transfer its WTRU capability information upon receiving a UECapabilityEnquiry message from the network by sending a UECapabilityInformation message.

The network may initiate the procedure to a WTRU in RRC_CONNECTED mode when it needs (additional) WTRU radio access capability information. The network should retrieve WTRU capabilities only after AS (Access Stratum) security activation. Network may not forward WTRU capabilities that were retrieved before AS security activation to the CN.

The WTRU capability may be requested per Radio Access Technology (RAT) type (e.g., NR, EUTRA, etc.). Additional filters may also be included in the capability request to limit the UL signaling as the size of all the WTRU capability information can be substantial and the network may already have some of the WTRU's capability information (e.g., from earlier capability transfer from the WTRU, from earlier capability transfer from the CN, etc.).

Another issue relates to the transition of the WTRU between different activity levels, e.g., from CONNECTED to INACTIVE/IDLE or vice versa. Current mechanisms for transitioning the WTRU from/to RRC_CONNECTED to/from RRC_INACTIVE/RRC_IDLE may be based only on the current data activity of the WTRU, and could lead to sub-optimal resource utilization, unnecessary signaling, and even sub-optimal WTRU power usage.

A WTRU, that has been sent to IDLE/INACTIVE, may end up transitioning back to connected state very soon afterwards due to the arrival of UL or DL data. On the other hand, a WTRU may remain in the INACTIVE/IDLE state for a long time, which means it could have been optimal for the network (and also for WTRU power saving) to transition the WTRU to INACTIVE/IDLE state even earlier.

In the discussion below, the term AI/ML is used to describe any model and associated learning algorithm used by the WTRU or/and network to predict future behavior (in this disclosure, the behavior or arrival of data at the WTRU to be sent to the network). The model and associated learning algorithm may be assumed to utilize a large set of data collected by the WTRUs and/or network. The details about the model and the associated learning algorithm are outside the scope of this disclosure. However, it may be assumed that the AI/ML model may make predictions based on several conditions such as current time, current WTRU location, WTRU mobility pattern, etc.

In the discussion below the terms “mode” and “state” are used interchangeably (e.g., IDLE mode and IDLE state)

In the discussion below, the terms “data volume/type” and “traffic volume/type” are used interchangeably.

In the discussion below, the terms “connection setup” and “connection establishment” are used interchangeably.

In the discussion below the terms “expected”, “anticipated”, “estimated”, “predictive” and “predicted” (and their adverb variants) are used interchangeably.

In the discussion below, the term “time horizon” is used to refer to the time (i.e., delta time from the current time) at which the predicted UL data is expected to arrive (i.e., ready to be sent) by the WTRU.

In the discussion below the term “normal BSR” is used to describe legacy BSR reporting up until NR rel-17 that is triggered when UL data actually arrives at the WTRU (e.g., regular BSR, padding BSR, periodic BSR, etc.).

### WTRU Configured to Trigger Connection Setup or Resume Based on Predicted UL Data Arrival

In some embodiments, the WTRU may be configured to trigger a connection setup (if it was in IDLE state), or a connection resume (if it was in INACTIVE state), when it predicts that UL data is expected to arrive within a given configured time. This may be further constrained by a configured accuracy level (or error range) of the prediction. For example, the WTRU may be configured to trigger connection setup or resume if UL data is expected to arrive within x ms, at an accuracy level of 90% (or error level of ±y Kbits). The WTRU may be provided with more than one such configuration. For example, the WTRU may be configured to trigger connection setup or resume if UL data is expected to arrive within x ms with an accuracy level of a1, or if UL data is expected to arrive within y ms with accuracy level of a2, etc.

In some embodiments, the WTRU may be configured to trigger a connection setup or connection resume when it predicts a certain volume of UL data is expected to arrive within a given configured time. This may be further constrained by a configured accuracy level (or error range) of the prediction. For example, the WTRU may be configured to trigger a connection setup/resume if UL data of at least A kbits is expected to arrive within x ms, at an accuracy level of 90% (or error level of ±y Kbits). In some embodiments, the accuracy level may be configured and/or determined in terms of confidence level associated with prediction of AIML model. The WTRU may be configured with multiple such configurations (i.e., different data volume, different time horizons, different accuracy).

In a variant of the above embodiments, a further granular configuration may be provided to the WTRU where the volume of UL data is specific to a certain type(s) of traffic. For example, if the WTRU is in INACTIVE mode, the traffic volume may be associated with one of the LCIDs or the bearer IDs of the saved WTRU context. As another example, the traffic volume could be associated with a certain QoS level of the traffic, for example, in terms of latency, bit rate, etc. As another example, the traffic volume could be associated with a certain application type (e.g., web browsing, streaming service, etc.). Different traffic volume levels for different types of traffic could also be specified. The traffic volume for a certain type of data (e.g., LCID, bearer ID, QOS level, application type, etc.) could be set to a very low value, e.g., 0, to indicate to the WTRU to trigger the connection setup/resume if any level of UL data is expected for such traffic type. In an embodiment, the WTRU may be configured with a traffic volume threshold for state transition based on UL data prediction for a subset of data flows (e.g., LCID, bearer ID, QOS level, application type etc.). In a first example, one or more data flows could be configured with a very high data volume threshold (e.g., infinity). In a second example, one or more data flows may not be configured/associated with any data volume threshold. In those two examples, the WTRU may disable the UL data prediction for those configured data flows and may not trigger RRC connection request and/or resume request based on data arrival prediction. The WTRU may be configured with several such configurations (e.g., different traffic types, different data volumes, different time horizons, different accuracy, etc.).

In some embodiments, the same configuration/behavior may be applied for IDLE and INACTIVE states.

In some embodiments, the configuration/behavior that is applied for IDLE and INACTIVE states may be different (e.g., different parameters such as thresholds specified for IDLE versus INACTIVE states).

### WTRU Configured to Trigger Connection Setup or Resume Based on Predicted DL Data

In the above embodiments, it was assumed that the WTRU behavior that triggered connection setup/resume may have been based on UL data prediction (either performed by the WTRU itself or provided by the network, e.g., via a paging-like message).

In some embodiments, the WTRU may also be capable of predicting DL data traffic, and may be configured to apply behavior similar to the above embodiments to trigger connection setup/resume based on DL data prediction.

In some embodiments, the network may be capable of predicting future DL data arrival. The WTRU may be configured to receive an indication from the network about upcoming DL data arrival, and then trigger a connection setup or resume procedure at a preconfigured time in the future, possibly closer to or aligned with the timing of actual DL data arrival. For example, the WTRU may receive a paging message from the network, and the paging message may additionally indicate the reason for paging. For example, a new access type may be defined that indicates predicted DL data arrival. Additionally, the WTRU may receive an indication about the timing of DL data arrival. Possibly, the timing may be expressed as an offset in terms of number of slots, subframes, or number of ms to the actual DL data arrival. The WTRU may be configured to initiate a random-access procedure at the earliest available RACH occasion immediately after the offset time from the paging message. Such an embodiment may be beneficial to reduce the latency between DL data arrival at the network and DL data delivered to the WTRU in IDLE/INACTIVE state. Possibly, such paging message with predicted DL data arrival may carry configuration for CFRA (Contention Free Random Access) resources. Possibly, such CFRA resources may be configured to be valid only for the purposes of connection setup with predicted DL data arrival. Possibly, such CFRA resources may be configured to be valid for a preconfigured time duration starting from the offset time. The above embodiments may also be extended for the use case where the network can also predict the UL data traffic arrival.

In some embodiments, the WTRU may be configured with multiple thresholds (e.g., a first threshold and a second threshold) associated with a prediction of UL data arrival, wherein the satisfaction of each threshold results in a different action by the WTRU. In one example, the thresholds may be associated with the data volume (e.g., a first threshold may correspond to a first data volume value/range and a second threshold may correspond to second data volume value/range). In another embodiment, the thresholds may be associated with a configured time frame (e.g., a first threshold may correspond to a first-time frame and a second threshold may correspond to a second time frame). In another embodiment, the thresholds may be associated with an accuracy level/confidence level of prediction (e.g., a first threshold may correspond to a first accuracy level/confidence level and a second threshold may to a first accuracy level/confidence level). In yet another embodiment, the thresholds may be associated with a combination of predicted data volume, time frame, and confidence level. In some embodiments, the WTRU may be configured with different actions based on determining if the UL data prediction satisfies the first threshold or the second threshold. For example, if the UL data prediction satisfies the first threshold, the WTRU may start the early measurements procedure, whereas, if the UL data prediction satisfies the second threshold, the WTRU may trigger transition to connected state and transmit connection request or resume request.

WTRU Configured to Indicate Connection Setup or Resume Cause that is Based on Predicted UL/DL Data

In some embodiments, the WTRU may be configured to include a cause value in the connection setup/resume request message (e.g., RRCSetupRequest, RRCResumeRequest) indicating that the connection setup/resume request is due to predicted UL data (e.g., a new cause value introduced, e.g., mo-Data-predicted, indicating a mobile originated data is predicted).

In some embodiments, the WTRU may be configured to include a cause value in the connection setup/resume request indicating that the setup/resume request is due to predicted DL data (e.g., a new cause value introduced, e.g., mt-Data-predicted, indicating a mobile terminated data is predicted).

In some embodiments, the WTRU may be configured to include a cause value in the connection setup/resume request message indicating that the setup/resume request is due to predicted UL or/and DL data (e.g., new cause value introduced, e.g., predicted-Data, indicating either UL or DL data is predicted, e.g., mt-and-mo-Data-predicted, indicating both UL and DL data is predicted).

In some embodiments, the WTRU may be configured to implicitly indicate that the connection is being setup/resumed due to predicted traffic. For example, the WTRU may be configured with certain dedicated RACH preambles that it can use during the RACH procedure before sending the setup/resume request, that is associated with data prediction. For example, the WTRU may be configured with preamble1, preamble 2 and preamble 3, and uses preamble 1 if the connection is being setup/resumed due to UL data prediction, uses preamble 2 if the connection is being setup/resumed due to DL data prediction, and uses preamble 3 if the connection is being setup/resumed due to both UL and DL data prediction.

In some embodiments, the WTRU may be configured to indicate during connection setup/request additional information about the predicted UL and/or DL data. For example, the additional information may include the specific data flows (e.g., LCID, bearer ID, QoS level, application type etc.) associated with the UL and/or DL data prediction. For example, the additional information may include an accuracy/confidence level of prediction. Alternately or additionally, the additional information may include the time offset to the arrival of predicted data. In one embodiment, the indication may be explicit, e.g., included in the connection setup/resume request. In another embodiment, the indication may be implicit, e.g., may be indicated via selection of RA resources preconfigured for specific values and/or value ranges associated with one or more of the additional information above.

In some embodiments, the WTRU may indicate only the legacy cause values in the RRCSetupRequest or RRCResumeRequest messages, but the network may request (in the RRCSetup or RRCResume messages, for example), an indication of whether the WTRU is resuming the connection due to predictions of data arrival or actual data arrival. The WTRU may send the response in the RRCSetupComplete or RRCResumeComplete message.

In some embodiments, the WTRU may be configured with different RACH related settings (e.g., power levels to use, power ramping parameters during preamble retransmissions, RAR-window, RACH occasions, etc.) to be used if the connection setup/resume is performed due to a predicted UL data rather than an actual data arrival. In another embodiment, the RACH related settings may be configured as a function of accuracy level and/or confidence level associated with the prediction.

### WTRU Configured to Indicate Predicted Traffic Volume During Connection Setup/Resume

In some embodiments, the WTRU may be configured to implicitly indicate during connection setup/resume the volume of the predicted traffic. For example, the WTRU may be configured with certain dedicated RACH preambles that it can use during the RACH procedure (i.e., msg1) that are associated with different level of traffic volume. For example, the WTRU may be configured with preamble1, preamble 2, preamble 3, and preamble 4, and uses preamble 1 if the connection is being setup/resumed due to a prediction of low volume of UL data, uses preamble 2 if the connection is being setup/resumed due to a prediction of medium volume of UL data, uses preamble 3 if the connection is being setup/resumed due to a prediction of a high level of UL data, and uses preamble 4 if the connection is being setup/resumed due to a prediction of a very high volume of UL data. Similarly, preambles may be configured that are associated with DL data volume (or a combination of UL/DL data volume). Preambles may also be configured that are associated with the time horizon of the prediction (e.g., a certain set of preambles for time horizon of less than a certain amount, another set of preambles for time horizon between two time values, etc.). Instead of or in addition to identification via preambles, other alternatives may be used such as using a specific beam (or associated RACH occasion for sending the setup/resume request if the setup/resume was triggered due to predicted data).

In some embodiments, the WTRU may send msg1 as indicated above that implicitly indicates the predicted traffic volume, but may not receive a response to that (i.e., no msg2).

In some embodiments, the WTRU may receive a msg2 (e.g., including a RAR that includes information such as TA, TC-RNTI), but it may not receive any UL grants. This may indicate to the WTRU not to proceed with msg3.

In some embodiments, the WTRU may receive a msg2 (e.g., including a RAR that includes information such as TA, TC-RNTI), but the specified UL grants may indicate future allocations (e.g., based on the time horizon of the traffic prediction), rather than current/immediate grants. This may indicate to the WTRU not to proceed with msg3 immediately, but at the specified time in the future.

In some embodiments, the WTRU may receive msg2 including a RAR that indicates the WTRU actions related to prediction. For example, the WTRU may receive an indication in RAR that the prediction-based connection request/resume should be disabled. For example, the WTRU may be configured to disable the prediction-based access attempts for a preconfigured duration. Possibly, the preconfigured duration may be explicitly indicated in the RAR message or as part of INACTIVE configuration or predefined in the standard. Possibly, the preconfigured duration may be infinite, i.e., until explicitly activated by the network.

In some embodiments, the WTRU may be configured to indicate the level of predicted traffic during connection setup/resume by including the information in the connection setup/resume request message (e.g., RRCSetupRequest, RRCResumeRequest). For example, an information element (IE) may be introduced (e.g., predicted traffic level) that can take certain value (e.g., 2 bits, 00 indicating low volume, 01 indicating medium volume, 10 indicating high volume, and 11 indicating very high volume). Two separate IEs may be used for indicating UL and DL data predictions.

In some embodiments, the WTRU may be configured to indicate the level of predicted traffic during connection setup/resume by including the information in the connection setup/resume complete message (e.g., RRCSetupComplete, RRCResumeComplete). For example, an IE may be introduced (e.g., predicted traffic level) that can take certain value (e.g., 2 bits, 00 indicating low volume, 01 indicating medium volume, 10 indicating high volume, 11 indicating very high volume). Two separate IEs may be used for indicating UL and DL data predictions. As another example, for a WTRU that was in INACTIVE state and that has a WTRU context, information similar to a BSR report (e.g., indexed traffic volume per LCG or even LCID) may be included, as the resume/setup complete messages do not have size restrictions like the request messages. In some examples, this predictive BSR report may include additional information, such as time horizon and accuracy level. In another example, the time horizon and accuracy level may be implicitly known by the network from the configuration it has provided to the WTRU.

In some embodiments, the predictive BSR may be sent as a MAC CE that is multiplexed with the RRCSetupRequest or RRCResumeRequest message (e.g., within the same MAC transport block).

In some embodiments, the predictive BSR may be sent as a MAC CE that is sent immediately after the RRCSetupRequest or RRCResumeRequest message (e.g., in a different MAC transport block).

In some embodiments, the predictive BSR may be sent as a MAC CE that is multiplexed with the RRCSetupComplete or RRCResumeComplete message.

In some embodiments, the predictive BSR may be sent as a MAC CE that is sent immediately after the RRCSetupComplete or RRCResumeComplete message.

In some embodiments, the WTRU may be configured to trigger the connection setup/resume as in legacy systems (e.g., only based on UL data arrival or paging from the network indicating DL data arrival), but it can use any of the mechanisms above to indicate the latest predicted UL and/or DL traffic level (e.g., use the new IEs in the setup/resume request messages, use the RACH preambles, etc.).

In some embodiments, the WTRU may be configured to trigger the connection setup/resume as in legacy systems (e.g., only based on UL data arrival or paging from the network indicating DL data arrival), but it can indicate the current UL traffic level (i.e., data available at the WTRU) and also the predicted UL and/or DL traffic level, using any of a combination of the embodiments above (e.g., use the new IEs in the setup/resume request messages for both the current and predicted data volumes, use the RACH preambles for the predictions while using the IEs in the request message for the current values, use the IEs in the setup/resume request messages for current data volume indication while using the setup/resume complete message for the predicted data volume, etc.).

In some embodiments, the network may request the WTRU to send the information about the predicted traffic during the setup/resume procedure. This could be, for example, in a RRCResume/RRCSetup message (e.g., a new IE), or in a random access response message before the Setup/Resume request is sent (e.g., a specific RAR pre-amble or RAR)

### How WTRU Configuration May be Performed

In some embodiments, the WTRU may be configured with the parameters/behaviors discussed in connection with any of the embodiments discussed above while it is in connected mode/state (e.g., in an RRC reconfiguration message).

In some embodiments, the WTRU may be configured with the parameters/behaviors discussed in connection with any of the embodiments discussed above during the transition to IDLE/INACTIVE mode (e.g., in the RRCRelease message).

In some embodiments, the WTRU may be configured with the parameters/behaviors discussed in connection with any of the embodiments discussed above using broadcast information (e.g., SIB).

A combination of all of the above is possible (e.g., some part of the configuration provided in RRCReconfiguration while the WTRU is in CONNECTED, a delta configuration on top of that provided in the RRCRelease, WTRU updating the configuration based on the SIB of a target cell when it performs cell re-selection, etc.)

In some embodiments, the WTRU may indicate its data prediction capabilities to the network while it is in connected state. This may include information such as prediction time horizon(s), confidence/accuracy/error levels, granularity of predictions, etc.

In some embodiments, the WTRU may be configured by the network as to a particular prediction capability (or capabilities) to be used (e.g., if the WTRU has multiple capabilities of making predictions, each with different time horizon values and accuracy level, the network may indicate to the WTRU which of those capabilities to used).

### Other Aspects

In some embodiments, the WTRU may detect that UL data is going to arrive based on some actions of the user rather than an AI/ML model (e.g., detecting the user has unlocked the screen, etc.).

In some embodiments, the WTRU may be capable of both UL and DL traffic prediction (or provided with either or both UL/DL data prediction from the network), and may be configured to apply similar behavior to the above embodiments by considering the UL prediction, the DL prediction, or a combination of them. For example:
UL predictions may take precedence over DL predictions (i.e., setup/resume decisions based on UL prediction only);
DL predictions may take precedence over UL predictions;
The WTRU may be configured with different parameters/threshold for UL and DL traffic, and apply the corresponding behavior independently;
The WTRU may take the UL or DL prediction into consideration, depending on which have the highest accuracy or/and lowest error level.

In some embodiments, the WTRU may predict UL data arrival in based on some actions of the user rather than an AI/ML model (e.g., detecting the user has unlocked the screen, etc.).

In some embodiments, the WTRU may initiate the resume/setup procedure in accordance with any of the embodiments above, but the network may respond with a RRCRelease message, instead of an RRCSetup or RRCResume message, thereby keeping the WTRU in RRC_IDLE or RRC_INACTIVE state. In one such example, the network may provide the WTRU with some additional information to be used when the actual data arrives (e.g., UL resources to be used to send the data).

In some embodiments, the WTRU may be configured to trigger a connection release when it predicts that there will be no UL data activity for a considerable time (e.g., configured time horizon). This can be further constrained by a configured accuracy level (or error range) of the prediction. For example, the WTRU may be configured to trigger connection release if no UL data is expected to arrive within x ms, at an accuracy level of 90% (or error level of #y Kbits). The WTRU may be provided with more than one such configuration. For example, the WTRU may be configured to trigger connection release if no UL data is expected to arrive within x ms with an accuracy level of a1, or if no UL data is expected to arrive within y ms with accuracy level of a2, etc.

In some embodiments, the WTRU may trigger the connection release by sending a connection release request (e.g., a new RRC message, RRCReleaseRequest). In other embodiments, the WTRU may send just assistance information to the network (e.g., using an enhanced version of the UEAssistanceInformation message). The RRCReleaseRequest or the UEAssistanceInformation message may include information such as:
The prediction (e.g., no UL data expected for x ms with an accuracy of n %);
The preferred state to transition to (e.g., IDLE, INACTIVE);
Any additional information that may help the network decide whether to accept the release message (e.g., current battery level, when UL data is expected, if at all, and what is traffic type; etc.).

In some embodiments, the WTRU, in response to sending the RRCReleaseRequest or UEAssistanceInformation message, may receive an RRCRelease message (i.e., legacy) indicating to transition to RRC_IDLE or RRC_INACTIVE state.

In some embodiments, the WTRU, in response to sending the RRCReleaseRequest message, may receive a rejection message (e.g., RRCReleaseReject) message that tells it to stay in RRC_CONNECTED state.

In some embodiments, the WTRU, in response to sending the RRCReleaseRequest or UEAssistanceInformation message, may receive an enhanced RRCRelease message. For example, time information may be included indicating to the WTRU that, if the WTRU's prediction remains correct within that time, the WTRU may release the connection. The WTRU then may start a timer, and if no UL data arrives or the WTRU prediction remains the same (e.g., no data expected), the WTRU may transition to the IDLE or INACTIVE state (as indicated in the receive RRCRelease message). The WTRU may send an indication about this action to the network (e.g., a new message such as RRCReleaseCompleted) message.

In some embodiments, the WTRU may indicate in the RRCReleaseRequest message whether it prefers to be transitioned to an IDLE or INACTIVE state.

In some embodiments, the WTRU, in the RRCReleaseRequest message (or in msg1, or in a MAC CE multiplexed with the RRCReleaseRequest message, etc.) may include information related to predicted buffer levels (e.g., how long the WTRU does not expect to get UL data, the confidence/accuracy level/error margins of the predictions, etc.)

### Examples

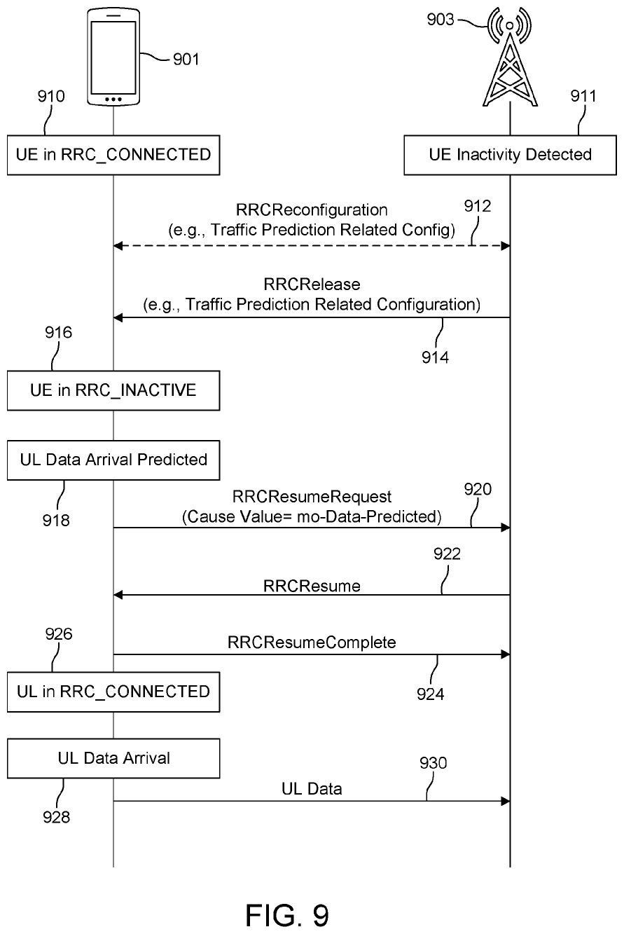

FIG. 9 is a signal flow diagram illustrating signal flow between a WTRU 901 and the network 903 in response to AI/ML at the WTRU predicting upcoming UL data for the WTRU in accordance with one exemplary embodiment. The WTRU 901 may start off in connected state 910.

At 911, the network 903 may determine that the WTRU has been inactive for a threshold duration and, thus determines to configure the WTRU to release its resources and enter RRC_INACTIVE state. At 912, the network may send the WTRU configurations related to the triggering of connection resume that are dependent on traffic prediction, such as time horizons, desired accuracy levels, volume of data for uplink transmission, etc. (e.g., trigger connection setup/resume when UL data of at least X KBs is expected to arrive within n ms, with an accuracy of p %). At 914, the network may transmit an RRCRelease message to the WTRU.

While steps 911, 912 and 914 are shown in a particular order in FIG. 9, it should be understood that at least some configuration information may be transmitted while the WTRU is in RRC_CONNECTED state (RRCReconfiguration 912 sent before step 911) or while it is transitioning to RRC_INACTIVE state. For example, the RRCReconfiguration message 912 may provide the WTRU with some “heavy” configuration information, such as the AI/ML models, while the release 914 may provide some light configuration, such as the triggering conditions for resume (e.g., the data thresholds or confidence levels) that will allow the WTRU to resume the connection, even before data has arrived. Alternatively, all the configuration information may be placed in just the Reconfiguration message 912 or just the release message 914.

While in the INACTIVE state 916, the WTRU may perform the UL data prediction 918, and, when the conditions for triggering connection resume based on the predictions are fulfilled (e.g., UL data of a certain volume is expected to arrive within a certain time at a given level of accuracy), the WTRU will trigger the connection resume request 920, indicating in the resume cause that the connection is resumed due to predicted UL data.

The network 902 may respond with an RRC resume message 922. The WTRU may transmit an RRC ResumeComplete message 924 back to the network and returns to RRC_CONNECTED state. Then, when the predicted data arrives, the WTRU may transmit the UL data 930.

Referring to FIG. 9, the WTRU was provided with some UL grant in line with the predicted data, and, if the predictions were accurate, the UL data may be directly (e.g., immediately) sent (as compared to the legacy case where the WTRU has to perform the connection resume, and maybe additionally need to send extra round trip times for sending SR/BSR and getting the required grants for the UL data).

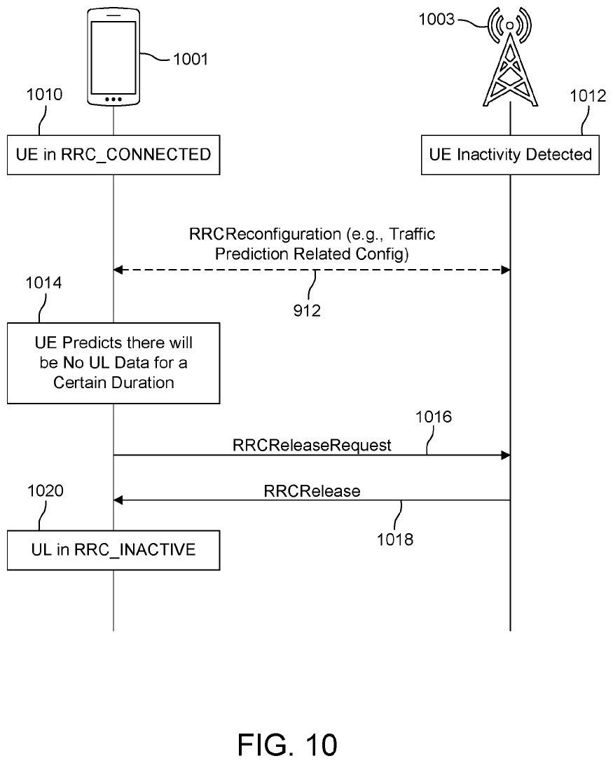

FIG. 10 is a signal flow diagram illustrating signal flow between a WTRU 1001 and the network 1003 in response to AI/ML at the WTRU predicting that there will be no upcoming UL data for a period in accordance with one exemplary embodiment. The WTRU may start out in RRC_CONNECTED state 1010 and the network detects that the WTRU has been inactive on the network for a period 1012. At 1014, AI/ML at the WTRU predicts that there will be no UL data for a certain duration. The WTRU may transmit an RRCReleaseRequest 1016 to the network. The network may grant the release by returning an RRCRelease message 108 to the WTRU, and the WTRU may enter RRC_INACTIVE state.

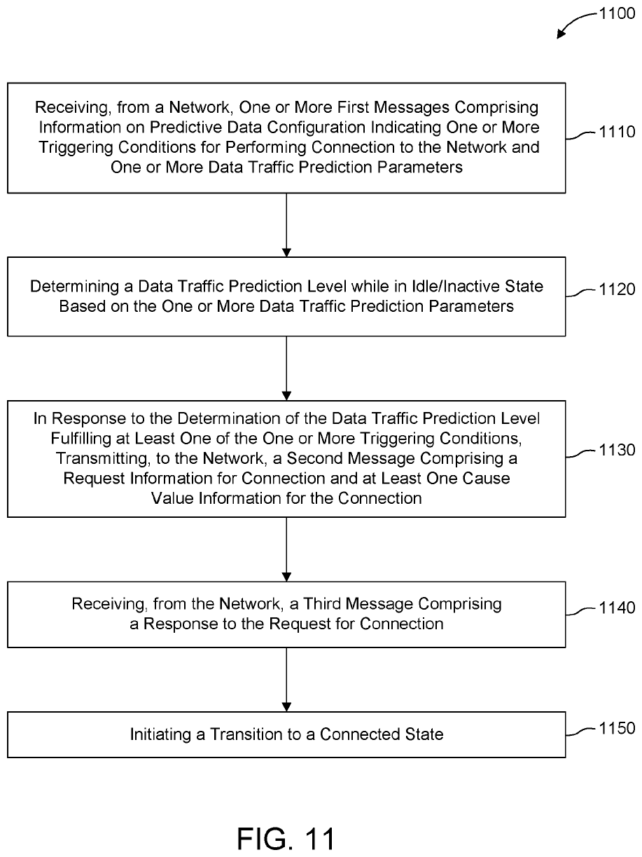

Referring to FIG. 11, a method 1100, implemented in a WTRU, for transitioning between connectivity states in a wireless communication network may comprise a step of receiving, from a network 1110, one or more first messages comprising information on predictive data configuration indicating one or more triggering conditions for performing connection to the network and one or more data traffic prediction parameters. The information on predictive data configuration indicating one or more triggering conditions may be received from the network by the WTRU in a first radio resource control release message. The information on predictive data configuration indicating one or more data traffic prediction parameters may be received from the network by the WTRU in second RRCRelease message. The method 1100 may comprise a step of determining 1120 a data traffic prediction level while in idle/inactive state based on the one or more data traffic prediction parameters. Determining the data prediction level may be based on any of current time, current WTRU location, and WTRU mobility pattern. In response to the determination of the data traffic prediction level fulfilling at least one of the one or more triggering conditions, the method 1100 may comprise a step of transmitting 1130, to the network, a second message comprising a request information for connection and at least one cause value information for the connection. The one or more data traffic prediction parameters may be related to prediction of arrival of data at the WTRU for uplink transmission and/or to prediction of arrival of data at the WTRU for downlink reception. The method 1100 may comprise a step of receiving 1140, from the network, a third message comprising a response to the request for connection; and a step of initiating 1150 a transition to a connected state.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

[1] 3GPP, “Radio Link Control (RLC) protocol specification”, TS 38.322, ver. 17.1.0, July 2022
[2] 3GPP, “Packet Data Convergence Protocol (PDCP) specification”, TS 38.323, ver. 17.1.0, July 2022
[3] 3GPP, “General aspects for Base Station (BS) Radio Frequency (RF) for NR”, TS 38.817, ver. 15.9.0, October 2020
[4] 3GPP, “Group Radio Access Network NR; NR and NGORAN Overall Description”, TS 38.300, ver. 17.1.0, July 2022

1. A method implemented in a wireless transmit receive unit, (WTRU), the method comprising:
receiving, from a network, one or more first messages comprising first information on a predictive data configuration, the first information indicating one or more triggering conditions for transitioning between an idle or inactive mode to a connected mode and indicating one or more data traffic prediction parameters;
receiving, from the network, a second message comprising second information indicating to transition from the connected mode to an idle or inactive mode;
performing a prediction of a data traffic level while in the idle or inactive mode, based on the one or more data traffic prediction parameters;
determining that the predicted data traffic level fulfills the one or more triggering conditions; and
in response to the determination, transmitting, to the network, a third message comprising third information indicating a request to transition to the connected mode and at least one cause value information for the request.

2-3. (canceled)

4. The method of claim 1, wherein the predicted data traffic level comprises a predicted uplink data traffic level, and wherein the at least one cause value information for the request indicates that the predicted uplink data traffic level fulfills at least one of the one or more triggering conditions.

5. The method of claim 1, wherein the one or more data traffic prediction parameters comprise any of a predicted arrival time of data at the WTRU, and a predicted volume of data based on the data due to arrive at the WTRU.

6. The method of claim 1, wherein the one or more triggering conditions comprises any of a time horizon for an arrival of data traffic, an accuracy threshold for the predicted data traffic level, and a volume of data traffic.

7. The method of claim 1, comprising performing the prediction of the data traffic level using an artificial intelligence/machine learning (AI/ML) model.

8. The method of claim 1, comprising performing the prediction of the data traffic level based on any of current time, current location of the WTRU, and a mobility pattern of the WTRU.

9. The method of claim 1, wherein the third message comprises fourth information indicating the request to transition to the connected mode is responsive to a prediction that data will be arriving at the WTRU and one or more of a predicted arrival time of data at the WTRU and a predicted volume of data based on the data due to arrive at the WTRU.

10. The method of claim 1, wherein the one or more data traffic prediction parameters are related to a prediction that data will be at the WTRU for any of uplink transmission and downlink reception.

11-13. (canceled)

14. A wireless transmit/receive unit, (WTRU), comprising a processor, a transceiver unit and a storage unit, and configured to:
receive, from a network, one or more first messages comprising first information on a predictive data configuration, the first information indicating one or more triggering conditions for transitioning between an idle or inactive mode to a connected mode and indicating one or more data traffic prediction parameters;
receive, from the network, a second message comprising second information indicating to transition from the connected mode to an idle or inactive mode;
perform a prediction of a data traffic level while in the idle or inactive mode, based on the one or more data traffic prediction parameters;
determine that the predicted data traffic level fulfills the one or more triggering conditions; and
in response to the determination, transmit, to the network, a third message comprising third information indicating a request to transition to the connected mode and at least one cause value information for the request.

15-16. (canceled)

17. The WTRU of claim 14, wherein the predicted data traffic level comprises a predicted uplink data traffic level, and wherein at least one cause value information for the request indicates that the predicted uplink data traffic level fulfills at least one of the one or more triggering conditions.

18. The WTRU of claim 14, wherein the one or more data traffic prediction parameters comprise any of a predicted arrival time of data at the WTRU, and a predicted volume of data based on the data due to arrive at the WTRU.

19. The WTRU of claim 14, wherein the one or more triggering conditions comprises any of a time horizon for an arrival of data traffic, an accuracy threshold for the predicted data traffic level, and a volume of data traffic.

20. The WTRU of claim 14, configured to perform the prediction of the data traffic level using an artificial intelligence/machine learning (AI/ML) model.

21. The WTRU of claim 14, configured to perform the prediction of the data traffic level based on any of current time, current location of the WTRU, and a mobility pattern of the WTRU.

22. The WTRU of claim 14, wherein the third message comprises fourth information indicating the request to transition to the connected mode is responsive to a prediction that data will be arriving at the WTRU and one or more of a predicted arrival time of data at the WTRU and a predicted volume of data based on the data due to arrive at the WTRU.

23. The WTRU of claim 14, wherein the one or more data traffic prediction parameters are related to a prediction that data will be at the WTRU for any of uplink transmission and downlink reception.

24-26. (canceled)

27. The method of claim 1, comprising:
receiving, from the network, a fourth message comprising a response to the request to transition to the connected mode; and
in response to reception of the fourth message, start operating in the connected mode and transmit to the network a fifth message indicating the transition to the connected mode has been successful.

28. The method of claim 1, wherein the first message is a first radio resource control release message or a radio resource control reconfiguration message, and wherein the second message is a second radio resource control release message.

29. The WTRU of claim 14, configured to:
receive, from the network, a fourth message comprising a response to the request to transition to the connected mode; and
in response to reception of the fourth message, start operating in the connected mode and transmit to the network a fifth message indicating the transition to the connected mode has been successful.

30. The WTRU of claim 14, wherein the first message is a first radio resource control release message or a radio resource control reconfiguration message, and wherein the second message is a second radio resource control release message.
